(19) United States
(12) Patent Application Publication
(10) Pub. No.: US 2005/0005040 A1
(43) Pub. Date: Jan. 6, 2005

(54) Motherboard for two users

(75) Inventor: Yi-Ping Chao, Shindian City (TW)

Correspondence Address: TROXELL LAW OFFICE PLLC, SUITE 1404, 5205 LEESBURG PIKE, FALLS CHURCH, VA, 22041, US

(73) Assignee: PALWIN TECHNOLOGY INC.

(21) Appl. No.: 10/610,812

(22) Filed: Jul. 2, 2003

(51) Int. Cl. G06F 13/10

(52) U.S. Cl. 710/62

(57) ABSTRACT

A motherboard for two-users comprised of a control chip with decoding function being integrated to the keyboard and mouse signals control loop of the USB connection ports of the motherboard, and is connected respectively to the redundant pins of the PS2 mouse and the PS2 keyboard connection ports; and the signal cables of the keyboard and the mouse being integrated into a single PS2 keyboard connector and a single PS2 mouse connector with both connectors respectively connected to the PS2 keyboard and the PS2 mouse connection ports of the motherboard for it to allow simultaneous control and operation by two sets of keyboard and mouse.

### BACKGROUND OF THE INVENTION

(a) Field of the Invention

The present invention is related to a motherboard for two users, and more particularly, to one that allows simultaneous control and operation by two keyboards and two mice.

(b) Description of the Prior Art:

As illustrated in FIG. 1 of the accompanying drawings of the present invention, a PC generally available in the market at present relates to a motherboard (not illustrated) contained inside a casing 10′ for the circuits and chips on the mother board to constitute a connection between the main hardware of a CPU (10) and its peripherals, and to provide conductivity to control and operate the CPU to execute commands by a keyboard (K) and a mouse (M). A user of the PC controls and operates commands to the CPU (10) essentially through the keyboard (K) and the mouse (N) that are mutually connected to the motherboard. Accordingly, additional to the built in various interface sockets to connect to peripherals, USB connection port, PS2 keyboard connection port and mouse connection port are generally provided to the motherboard to for connecting both of the keyboard and the mouse to the motherboard.

As illustrated in FIGS. 2 and 3, the PS2 keyboard connection port of the motherboard of the prior art is exclusively provided for the plug by the keyboard. Therefore, the corresponding PS2 keyboard connector (21) is provided with two power pins (211) and two keyboard signal pins (212) to be connected to the operation loop of the motherboard while two idling pins (213) are provided. Similarly, the PS2 mouse connection port of the motherboard of the prior art is exclusively provided for the plug by the mouse. Therefore, the corresponding PS2 mouse connector (22) is provided with two power pins (221) and two mouse signal pins (222) to be connected to the operation loop of the motherboard while two idling pins (223) are provided.

When the CPU is in use, the PS2 keyboard connection port provides the conductivity for a single keyboard, and the PS2 mouse connection port, for a single mouse. The entire unit of the motherboard is provided only for the connection by one set of the keyboard and the mouse in the mode of one-man use and operation without taking advantage of the existing hardware resources of the motherboard and those adapted in the slots of the motherboard.

### SUMMARY OF THE INVENTION

The primary purpose of the present invention is to provide a motherboard for simultaneous use by two users. To achieve the purpose, a control chip with decoding function is integrated to the keyboard and mouse signals control loop of the USB connection ports of the motherboard, and is connected respectively to the redundant pins of the PS2 mouse connection port and the PS2 keyboard connection port. The signal cables of the keyboard and the mouse are integrated into a single PS2 keyboard connector and a single PS2 mouse connector with both connectors respectively connected to the PS2 keyboard connection port and the PS2 mouse connection port of the motherboard.

Accordingly, keyboard signals inputted from the PS2 keyboard connection port are operated by the existing PS2 keyboard signal control loop, and the inputted mouse signals are operated by the existing USB mouse signal control loop via the connection of the control chip. Signals from the mouse inputted by the PS2 mouse connection port is operated by the existing PS2 mouse signal control loop, and the inputted keyboard signals are operated by the existing USB keyboard signal control loop via the connection of the control chip thus to achieve that the motherboard in the same CPU is capable of serving two sets of keyboard and mouse.

### BRIEF DESCRIPTION OF THE DRAWINGS

FIG. 1 is a schematic view showing the status of a CPU of the prior art in use.

FIG. 2 is a schematic view showing the layout of the structure of pins of a PS2 keyboard connector from the motherboard of the prior art.

FIG. 3 is a schematic view showing the layout of the structure of pins of a PS2 mouse connector from the motherboard of the prior art.

FIG. 4 is a block chart of the connection configuration for a control chip of the present invention with a USB keyboard and mouse control loop, and a PS2 keyboard connection port and a PS2 mouse connection port.

FIG. 5 is a view of a reference circuit of the control chip, a keyboard control loop and a mouse control loop of the present invention.

FIG. 6 is a schematic view showing the layout of the structure of pins of a PS2 keyboard connector from the motherboard of the present invention.

FIG. 7 is a schematic view showing the layout of the structure of pins of a PS2 mouse connector from the motherboard of the present invention.

FIG. 8 is a schematic view showing a CPU of the present invention is connected to two sets of keyboard and mouse.

FIG. 9 is a schematic view showing the status of the CPU containing the motherboard of the present invention is in use.

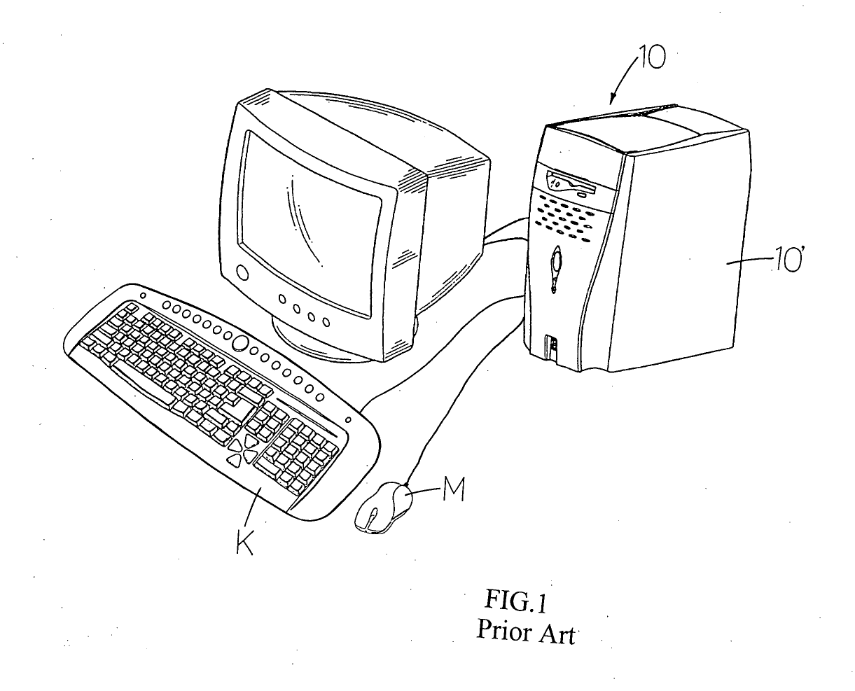

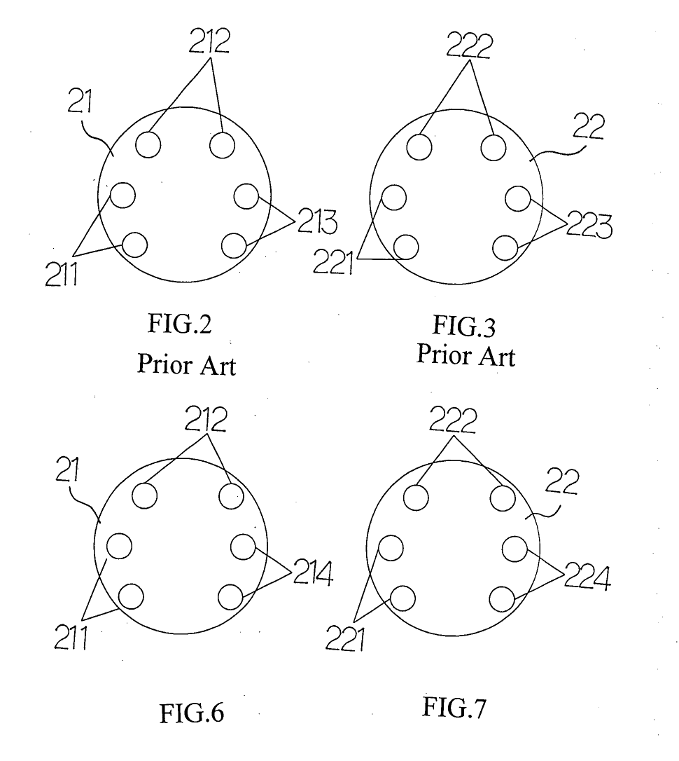

### DETAILED DESCRIPTION OF THE PREFERRED EMBODIMENTS

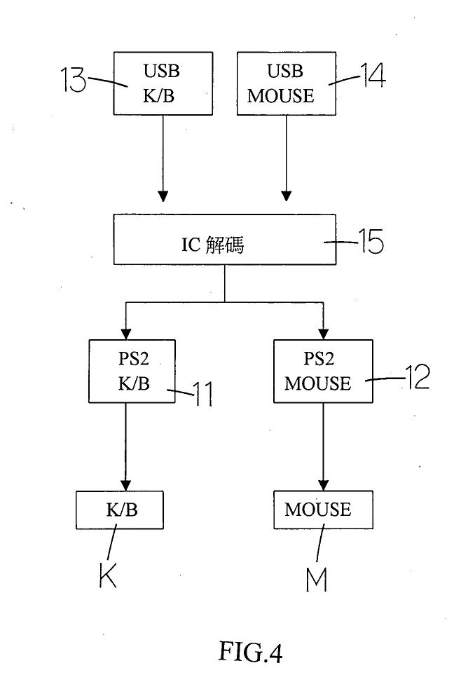

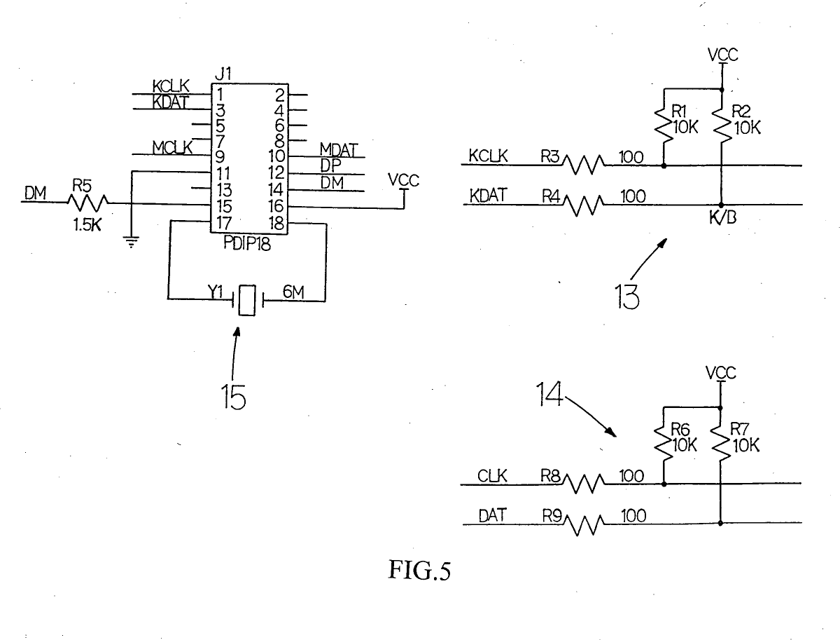

A motherboard for two users of the present invention relates to a motherboard arranged with circuits and chips to provide the connection between a CPU primary hardware facilities and their peripherals, various interface sockets for the connection by the peripherals, a USB connection port, a PS2 keyboard connection port, a PS2 keyboard connection port and a mouse connection port to provide connectivity for a keyboard and a mouse. As illustrated in FIGS. 4 and 5, a control chip (15) with decoding function is separately integrated into a keyboard signal control loop (13) and a mouse signal control loop (14) of the USB connection port of the motherboard, and the control chip (15) is connected to multiple redundant pins of a PS2 mouse connection port (12) and to multiple redundant pins of a PS2 keyboard connection port (11).

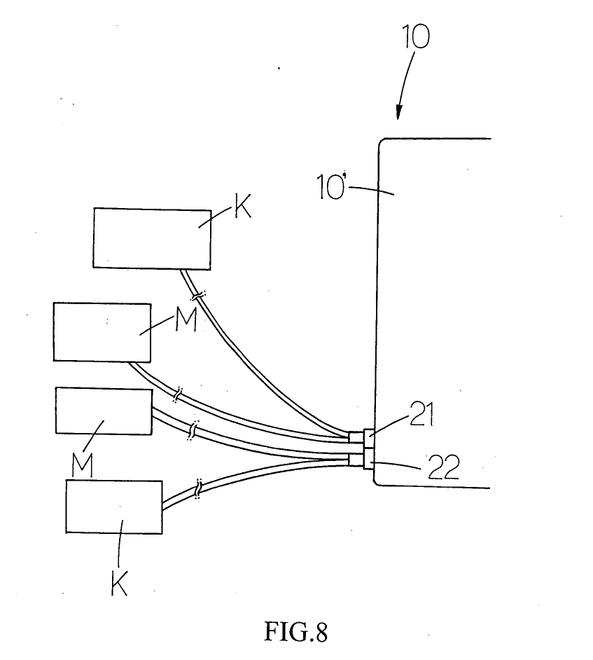

Referring to FIGS. 6, 7 and 8, signal cables from a keyboard (K) and a mouse (M) used to connect a CPU (10) are integrated into a single PS2 keyboard connector (21) containing two power pins (211), two keyboard signal pins (212) and two mouse signal pins (214); and a single PS2 mouse connector (22) containing two power pins (221), two mouse signal pins (222) and two keyboard signal pins (224) with both of the PS2 keyboard connector (21) and the mouse connector (22) respectively connected to the PS2 keyboard connection port and the PS2 mouse connection port of the motherboard.

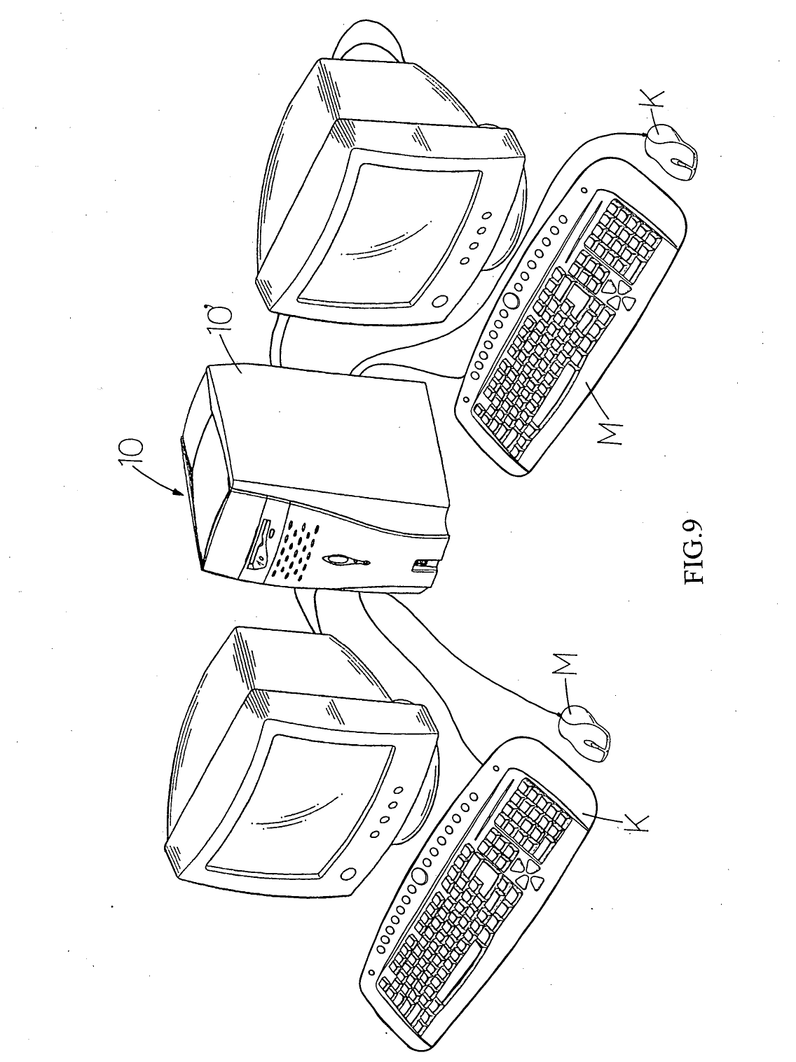

Accordingly, keyboard signals inputted from the PS2 keyboard connection port are operated by the existing PS2 keyboard signal control loop, and the inputted mouse signals are operated by the existing USB mouse signal control loop via the connection of the control chip. Signals from the mouse inputted by the PS2 mouse connection port is operated by the existing PS2 mouse signal control loop, and the inputted keyboard signals are operated by the existing USB keyboard signal-control loop via the connection of the control chip. As illustrated in FIG. 9, the motherboard in the CPU (10) is capable of serving two sets of keyboard (K) and mouse (M) for further taking advantage of the resources of the existing hardware and that adapted to the slots of the motherboard.

As disclosed, a motherboard for two-user of the present invention by providing a motherboard that allows simultaneous control and operation by two sets of keyboard and mouse significantly upgrade the availability of a motherboard. Therefore, this patent application is duly filed. However, it should be noted that the preferred embodiment and accompanying drawings of the present invention are provided not to limit the present invention, and any structure, device, characteristics that are identical with or similar to that of the present invention shall be deemed as falling within the scope of the purpose and the claim of the present invention.

1. A motherboard for two-users is essentially comprised of a control chip with decoding function being integrated to the keyboard and mouse signals control loop of the USB connection ports of the motherboard, and connected respectively to the redundant pins of the PS2 mouse connection port and the PS2 keyboard connection port; the signal cables of the keyboard and the mouse are integrated into a single PS2 keyboard connector and a single PS2 mouse connector with both connectors respectively connected to the PS2 keyboard connection port and the PS2 mouse connection port of the motherboard; keyboard signals inputted from the PS2 keyboard connection port being operated by the existing PS2 keyboard signal control loop, and the inputted mouse signals being operated by the existing USB mouse signal control loop via the connection of the control chip; and signals from the mouse inputted by the PS2 mouse connection port being operated by the existing PS2 mouse signal control loop, and the inputted keyboard signals being operated by the existing USB keyboard signal control loop via the connection of the control chip thus to achieve that the motherboard in the same CPU being capable of serving two sets of keyboard and mouse.

2. A motherboard for two-users as claimed in claim 1, wherein, the PS2 keyboard connector is provided with two power pins, two keyboard signal pins and two mouse signal pins.
